(19) United States
(12) Patent Application Publication
(10) Pub. No.: US 2005/0064317 A1
(43) Pub. Date: Mar. 24, 2005

(54) Thermal, pressure activated transfer media

(75) Inventors: Walter von Wirth, Adliswil (CH); Gunter Wendler, Burgdorf (CH); Catalin Ghimboasa, Zurich (CH); Siegmund Hotzl, Thalwil (CH)

Correspondence Address: OPPENHEIMER WOLFF & DONNELLY LLP, 45 SOUTH SEVENTH STREET, SUITE 3300, MINNEAPOLIS, MN, 55402, US

(73) Assignee: SIHL GROUP, AG, Zurich (CH)

(21) Appl. No.: 10/916,952

(22) Filed: Aug. 12, 2004

Related U.S. Application Data
(60) Provisional application No. 60/495,479, filed on Aug. 15, 2003.

(51) Int. Cl. G03G 15/14; B32B 27/30

(52) U.S. Cl. 430/126; 428/522; 428/32.1

(57) ABSTRACT

A electrographic element (10) having a base substrate (12), a conductive layer (14), a single, integral dielectric/adhesive/release layer (16) upon which an image is deposited, and an optional final substrate (20) and a method of making the electrographic element are disclosed. The single, integral dielectric/adhesive/release layer is preferably a co-polymer of polyvinylchloride and polyvinyl acetate. A method of making the electrographic element is also disclosed.

### CROSS-REFERENCE TO RELATED APPLICATIONS

This application claims the benefit of U.S. Provisional Application No. 60/495,479, filed Aug. 15, 2003.

### BACKGROUND OF THE INVENTION

1. Field of the Invention

This invention relates generally to transfer technology. In particular, this invention relates to an electrographic imaging element having an electrographic imaging layer with combined dielectric, adhesive and release functionalities and a process for accomplishing the foregoing.

2. Description of the Related Art

Transfer technology has evolved from metal stamping, carbon copying and lithography to the modern process of electrographic transport. The use of electrographic transport to create multicolor images is widely known in the art. The electrostatic latent image is created by imagewise deposition of electrical charge directly onto a dielectric surface. The latent image is created by charged styli arranged in linear arrays across the width of the moving dielectric surface. Such processes are disclosed, for example, in U.S. Pat. Nos. 4,007,489; 4,569,584; and 4,731,542.

Electrographic transfer technology consists of depositing an electrostatic latent image onto a receiving substrate. There are six necessary components for an electrographic transfer product. They are a carrier sheet (or base substrate), a conductive layer, a release layer that provides release of the toned dielectric, the dielectric layer itself, an adhesive component to bond the toned dielectric to the final substrate, and a final substrate, typically vinyl, to protect the imaged paper. The process of creating an electrographic imaged product includes depositing an image onto the dielectric layer, laminating the imaged dielectric layer with a final substrate, typically vinyl, via the addition of pressure and/or heat and releasing the laminated, imaged dielectric layer from the base substrate to produce an imaged product.

Early attempts to advance transfer technology combined functional components that resulted in fewer overall elements and steps in the process of electrographic imaging. For example, U.S. Pat. Nos. 5,363,179; 5,400,126; and 5,475,480 disclose a transfer product with a conductive quaternary ammonium polymer conductive agent. The receiving substrate was prepared by coating a base substrate or carrier sheet with a conductive layer over which both a dielectric layer and a separate tack-free adhesive layer were placed. The image was deposited on the adhesive layer and a final substrate was then applied by pressure laminating the final substrate to the toned image layer. The carrier sheet together with the conductive layer were released from the toned dielectric layer. U.S. Pat. No. 5,400,126 discloses the use of a separate release layer positioned between the base substrate and the conductive layer or between the conductive layer and the dielectric layer. However, there were problems with maintaining the image integrity during the release step and providing printing for heat sensitive substrates. In addition, the total number of layers utilized made the final product costly and impractical to produce.

U.S. Pat. Nos. 5,370,960 and 5,414,502 discloses the use of a separate protective layer with greater durability than that afforded by a dielectric layer alone. The protective layer is part of the dielectric layer and consisted of cellulose acetates and polyvinylchlorides but having a three-layer dielectric made it impractical to produce.

U.S. Pat. No. 5,483,321 discloses a combined tack-free adhesive dielectric layer and a separate release layer. The combined adhesive-dielectric was a single layer. A release layer was applied over the conductive layer on a coated base paper. The release layer consisted of a silicone formulation that was electron beam cured. The conductive base was prepared by coating it with a separate release layer. A single combined dielectric and adhesive layer was layered onto the separate release layer. The image was deposited onto to combined dielectric the tack-free dielectric layer whose adhesive properties were activated with the addition of pressure and/or heat during the lamination process. The primary problem with this type of structure was the separate application of the release layer, which was costly and time consuming.

U.S. Pat. Nos. 5,601,959 and 5,789,134 disclose an alternative construction which attempted to address the problems associated with the art. The alternative construction used a non-adhesive dielectric coating, which released from the conductive layer and included a final substrate that had adhesive qualities. However, the electrographic element utilized five, and optionally six, separate layers. In addition, the non-adhesive dielectric coating did not adhere well to the conductive layer, which was a major impediment to this type of electrographic element from being implemented. Further, multi-layered extrusions were not suitably commercializable.

U.S. Pat. No. 5,688,581 discloses a dielectric layer that is applied in two parts on the conductive release paper. A more durable material than existing dielectric polymers was applied in a think layer onto the release layer.

U.S. Pat. Nos. 5,707,554; 5,869,179; 5,883,212; and 6,171,422 generally discloses a conductive layer having release characteristics and a dielectric layer having adhesive characteristics. The conductive layer was developed by solubilizing monomers with silicone sub-units into a quaternary ammonium monomer formulation, which was then cured by ultraviolet light. While, curing the conductive layer had the advantage of eliminating a processing step (i.e. a coating pass), it created the additional step of having to cure the layer.

Despite the advances made in electrographic imaging, there continues to be a need for a more efficient and cost effective process that has fewer layers, releases cleanly from the conductive layer and provides protected, distortion-free, full color images for traditional paper printing applications as well as large format posters, bulletin boards, vehicles and other large scale, outdoor applications.

### SUMMARY OF THE INVENTION

These needs are met by the transfer technology and electrographic imaging process of the present invention. It is an object of the present invention to reduce the number of layers in the electrographic element from 6 to 4. It is a further object of the present invention to provide an electrographic element that includes a base substrate, a conductive layer, a single, integral dielectric/adhesive/release layer upon which an image is deposited, and a final substrate. Unlike the conventional art, the single, integral dielectric/adhesive/release layer releases cleanly from the conductive layer. Moreover, the addition of a fatty acid or fatty alcohol additive, or additives, inhibits chemical interactions between ambient moisture and ink pigments and provides for cleaner release without residue when using inks with high concentrations of calcium carbonate and/or silica.

The invention also includes an electrographic element having a single, integral dielectric/adhesive/release layer, the dielectric/adhesive/release layer comprising a co-polymer having the structure —[CH₂CHX]— . . . —[CH₂—CHY]; wherein X is selected from the group consisting essentially of —CN, —NO₂, —Br, —Cl, —F, —I and -AR; wherein Y is selected from the group consisting essentially of polyvinyl acetate, an acrylic ester, and polyvinylbutyral, wherein X has a high negative induction effect on the co-polymeric structure, wherein —[CH₂CHX] imparts release characteristics and —[CH₂—CHY]— imparts adhesive characteristics to the dielectric/adhesive/release layer.

If the toned image contains a high concentration of pigments with calcium carbonate and or small amounts of silica it is preferable to add a hydrophobic additive to the initial composition to reduce the attraction of the pigments for water in the environment. Therefore, the composition for the dielectric/adhesive/release layer may also contain trace amounts of a hydrophilic additive for stabilizing the release mechanism of the single, integral dielectric layer wherein the additive is preferably from about 0.05 wt. % to about 1.0 wt. % of a fatty acid or its alcohol derivative and more preferably a higher fatty acid such as pelargonic, lauric, myristic, palmitic and stearic and their corresponding alcohol derivatives. More preferably the fatty acid or fatty alcohol is added in an amount of from about 0.05 wt. % to about 0.2 wt. %.

In an alternative embodiment of the present invention, a blend of homopolymers of —[CH₂CHX]— and —[CH₂—CHY]— may be used instead of the co-polymer composition. In the alternative embodiment, —[CH₂CHX]— is preferably from 30 wt. % to about 100 wt. % and —[CH₂—CHY]— is preferably from about 70 wt. % to about 0 wt. %.

The invention also includes a method of producing an imaged article including (i) depositing an electrostatic charge in image-wise fashion onto an image receptive surface of an electrographic element, the electrographic element comprising (a) a base substrate; (b) a conductive layer; (c) a single, integral charge-receptive dielectric layer having release and adhesive functionalities; (ii) applying a toner layer onto the single, integral charge-receptive dielectric layer to produce a toned image; (iii) contacting the toned image surface of the single, integral dielectric layer having release and adhesive functionalities with a final substrate at a temperature and pressure sufficient to activate the adhesive properties of the single, integral dielectric layer having adhesive and release functionalities to adhere the electrographic element to the final substrate; (iv) releasing the single, integral dielectric layer having adhesive and release functionalities containing the toned image and final substrate from the conductive base to produce an imaged article.

The aforementioned objects and resulting advantages will become apparent from the following detailed description in conjunction with the accompanying drawings.

### BRIEF DESCRIPTION OF THE DRAWINGS

FIG. 1 is a perspective view of an electrographic imaging element in accordance with the present invention illustrating details of the constituent elements.

FIG. 2 is a graphic representation of a lamination process used to produce an imaged article in accordance with the present invention.

### DETAILED DESCRIPTION OF THE INVENTION

The present invention relates to a new and improved electrographic imaging element including a base substrate, a conductive layer, and a single, integral dielectric layer having both release and adhesive functionalities that is tack-free at ambient conditions. The adhesive function is activated at a pressure and/or temperature above the ambient pressure and temperature of the electrographic element. The single, integral dielectric layer having release and adhesive functionalities is formed from a novel co-polymer or homopolymer composition that provides both release and adhesion and that is used as a single imaging element in heat transfer technology applications and in particular in electrographic imaging processes. The imaging element of the present invention is described below with reference to the accompanying drawings.

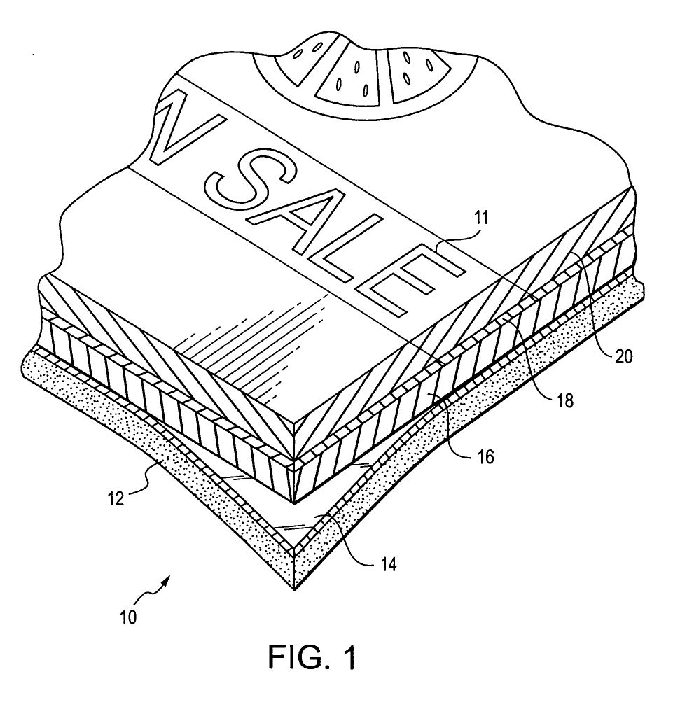

Referring to FIG. 1, a laminated electrographic image element (10) comprises a base substrate (12), a conductive layer (14), a single, integral dielectric/adhesive/release layer (16), a latent toned image layer (18), and a final substrate layer (20).

The base substrate (12) provides support for the layers used during the electrographic imaging process in this invention. The base substrate (12) is preferably any web or sheet material possessing suitable flexibility, dimensional stability and adherence properties to the conductive layer. The base substrate (12) may include metal foils such as aluminum and metalicized polyethylene terephthalate film; flexible polymeric films such as polyethylene terephthalate; or a foraminous material such as paper, foamed polyethylene or polypropylene. In accordance with one embodiment of the present invention, the base substrate is conductive paper. In accordance with one embodiment of the present invention, the base substrate is paper or conductive paper. These papers have a bulk conductivity from either having conductive ingredients in the pulp or by size press treatment. The base substrate (12) may also be coated with a conductive layer (14) to enhance the desirable electrographic characteristics of the base substrate. The conductive layer (14) augments the electrical or semi-conductive properties of the base substrate (12) to optimize the electrical resistivity of the receiving substrate and is applied onto the base substrate (12). In the formative years of this technology hygroscopic metal salts like zinc chloride or magnesium chloride were used to augment electrical and conductive properties of the base substrate. Presently, solid components such as laponites (sodium silicates with high conductivity), doped tinoxide or polymeric quaternary ammonium materials are used. Sodium or potassium salts of sulfonic acids like p-toluene sulfonic acid are also suitable for this purpose; however they tend to cause or be susceptible to corrosion. Water soluble binders like starch, modified cellulose or polyvinylalcohol are used to reduce tackiness and/or create a desired range for solvent hold for the following layer created from organic solvents. Attempts have also been made to use pigments like dope tinoxide (doped by the use of Sb, N or others). The advantage of those pigments are that they are not pending on environmental humidity but they are lacking from rather high material costs compared to the other options. Resulting conductivity very much depends on the components used but also on the weight of the coating that is applied onto the substrates. A range of from about 10⁵ to 10⁷ Ohms results in a substrate that is very well covered. Preferred bulk conductivities are from 0.5 to 9 MegaOhms.

A single, integral dielectric/adhesive/release layer (16) which is applied to the conductive layer (14) may be any film forming co-polymer or blended homopolymer composition that includes both release and adhesion functionalities. By adhesion and release properties we mean properties that cause the single dielectric/adhesive/release layer (16) to be sufficiently adhered to the conductive base to permit handling of the electrographic element (10) throughout processing without adhesion failure. However, once the latent toned image layer (18) is generated and passed through a heat activation device, such as a laminator, the single, integral dielectric/adhesive/release layer will perform excellent adhesion to the final substrate (20), typically vinyl. The adhesion of the integral dielectric/adhesive/release layer (16) onto the conductive layer (14) is less that the adhesion of the latent toned image layer (18) to the dielectric/adhesive/release layer. Therefore the laminate can be peeled off easily from the conductive layer (14) without remaining residue.

The single, integral dielectric/adhesive/release layer (16) may be any film forming, co-polymer composition that includes both release and adhesion functionalities. The single, integral dielectric/adhesive/release layer is a co-polymer having the structure —[CH₂CHX]— . . . —[CH₂CHY]—. In the dielectric/adhesive/release layer in accordance with the present invention [CH₂CHX]— comprises approximately from 10 wt. % to 99 wt. % of the co-polymer and —[CH₂CHY]— comprises approximately 90 wt. % to 1 wt. % of the co-polymer. There is no need for a specific sequence of —[CH₂CHX]— . . . —[CH₂CHY]— in the co-polymer composition. In an alternative embodiment in accordance with the present invention, a homopolymer may be used for both adhesion and release when a certain glass transition temperature and melting point are maintained. When X is polyvinylchloride or chlorinated polyethylene, the lamination step of the process will produce the proper temperature within the range of glass transition temperatures and melting point temperatures such that the homopolymer may exhibit sufficient adhesion and release characteristics. Melting points of from about 70° C to about 150° C. create the desired characteristics. In an alternative embodiment of the present invention, a blend of homopolymers of —([CH₂CHX]) and —[CH₂—CHY]— may be used. In such an alternative embodiment, —[CH₂CHX]— may be present in the solution from 30 wt. % to about 100 wt. % and —[CH₂—CHY]— may be present from about 70 wt. % to about 0 wt. %.

The first polymer, —[CH₂CHX]—, is responsible for the release characteristics of the present invention, where X is a constituent having a high negative induction effect such as —CN, —NO₂, —Br, —Cl, —F, —I and -AR. Suitable constituents in accordance with the present invention include —Cl, as in polyvinylchloride; -AR, aromatic partners such as phenyl, naphtyl and other such substituents unless they have a positive induction effect and/or have the ability to form hydrogen bonding; —CN, as in polyacryinitrile; and —F, as in polyvinylfluoride. Referring to Table 1 below, Vinnolit P70 F (100 wt. % polyvinyl chloride); polyvinylfluoride; polyacrylnitril; and polystyrene homopolymers were tested by applying an approximately 5 μm coating of each on polyethylene coated paper, aluminum foil, and glass with a Mayr rod. The samples were then fed through a Neschen Jet Lam 1600 laminator set at 80° C. on the substrate side, 135° C. on the paper side, and a pressure of 8 psi. After peel testing, these homopolymers exhibited good release characteristic. The term “good release” as used herein means that a reasonable amount of force was used in the peel test and there was no residue remaining on the conductive paper after release.

Adding an additional electronegative atom on the CHX structure will reduce the dipole moment and consequently improve the adhesive properties. Thus, as a general rule, one skilled in the art would want to increase the dipole moment of the molecule up to a certain point. If X is hydrogen, the backbone comprises polyethylene and demonstrates unacceptable adhesive properties depending on the base substrate.

The first polymer disclosed above may be combined with a second polymer having the structure —[CH₂—CHY]— in a co-polymeric composition or blend of homopolymers. This second polymer exhibits adhesive properties and Y is preferably a polyvinylacetate, polyvinylbutyral, or an acrylic ester. Inclusion of polyvinylacetate in a co-polymer that exhibits release characteristics produces surprising and unexpected results because polyvinylacetate is typically a polymer that has strong adhesive characteristics. For example, when combined with polyethylene (i.e. X is hydrogen) the polyethylene-polyvinylacetate co-polymer is used as a backbone component in adhesive formulations such as ELVAX (DuPont) and LEVAPREN (Bayer). However, in the co-polymeric structure or blend of homopolymers in accordance with the present invention polyvinylacetate is responsible for imparting adhesive characteristics to the overall composition without negatively impacting the release function of the composition. According to Table 1 below, the co-polymers that achieved desirable adhesive properties when applied to polyethylene paper, aluminum foil, and glass were as follows: Vinnol 15/50 (85 wt. % polyvinyl chloride; 15 wt. % polyvinyl acetate) (Wacker Polymer Systems, Munich, Germany); Vinnol 40/50 (63 wt. % polyvinyl chloride; 37 wt. % polyvinyl acetate) (Wacker Polymer Systems, Munich, Germany); and Polymer 2 (See Example 8 below).

Ambient moisture can effect the stability of adhesion and release for the dielectric/adhesive/release layer (16) because water in the system interacts with calcium carbonate, a compound present in most ink pigments used to form the latent toned image layer (18). Therefore, the inventors have found that it is desirable to add trace amounts of an additive to the single, integral dielectric/adhesive/release layer (16) to stabilize the release mechanism of the co-polymer by inhibiting the attraction between water and calcium carbonate. The additive is preferably from about 0.05 wt. % to about 1.0 wt. %, more preferably from about 0.05 wt. % to about 0.05 wt. %, and most preferably from about 0.05 wt. % to about 0.02 wt. % of a fatty acid fatty acid or the corresponding alcohol derivative and more preferably a higher fatty acid such as pelargonic, lauric, myristic, palmitic and stearic and the corresponding fatty alcohols. In one embodiment of the present invention stearic acid or stearyl alcohol is most preferred when the final substrate (20) is 80 w. % polyvinyl chloride, as commonly used in the industry.

Referring to Table 1 below, tested polymers exhibiting strong negative induction effects, the associated dipole moments and the base substrate used to test for adhesion and release are set forth. The co-polymers were tested on metal and glass in addition to paper substrates because glass and metal substrates are inert, allowing better quantification of adhesion and release without considering extrinsic chemical interactions between the co-polymer and the substrate.

TABLE 1
Evaluation Adhesion and Release as a Response to Induction Effects

| Polymer | Chemical nature | Binding moments (Exner) | I effect | PE paper | Alu Foil | Glass |
|---|---|---|---|---|---|---|
| Homopolymers | | | | | | |
| Vinnolit P70 F | 100% PVC | 1.7 (C—Cl) | −− | R+ | R+ | R+ |
| Polyvinylfluorid | 100% PVF | 1.4 (C—F) | −− | R+ | R | R |
| Polyacrylnitril | 100% PAN | 3.6 (C—CN) | −− | R+ | R+ | R+ |
| Polystyrene | 100% Styrene | na | −− | R+ | R+ | R+ |
| Copolymers | | | | | | |
| Vinnol H 15/50 | 85% VCl; 15% VAc | 1.7 (C—Cl)/0.74 (C—O) | −−/− | R+ | R | R |
| Vinnol H 40/50 | 63% VCl, 37% VAc | 1.7 (C—Cl)/0.74 (C—O) | −−/− | R+ | R+ | R+ |
| Laroflex M45 | 77.5% VCl; 22.5% | 1.7 (C—Cl)/0.74 (C—O) | −−/+++ | A+ | A+ | A |
| | Vinylisobuthylether | | | | | |
| Polymer 2 | 85% VCl; 15% VAc | 1.7 (C—Cl)/0.74 (C—O) | −−/− | R+ | R | R |
| Polymer 3 | 83.0% VCl; 17% | 1.7 (C—Cl)/0.74 (C—O) | −−/+ | A+ | R | A+ |
| | Vinylpropionate | | | | | |
| Polymer 4 | 81.1% VCl; 18.9% | 1.7 (C—Cl)/0.74 (C—O) | −−/++ | A+ | A+ | A+ |
| | Vinlybutyrate | | | | | |

The single, integral dielectric/adhesive/release layer (16) may be any thermoplastic resin with a Pauling rating or dielectric constant of 0.7 min. This layer typically includes one or more polyvinyl resins selected from the group consisting of acrylics, styrene copolymers, Vinnolit P70 F, polyvinylfluoride, vinylfluoride, monofluoroethylene, polyacrylnitril, 2-propenenitrile, acrylnitrile, cyanoethylene, vinyl cyanide, polystyrene, homopolymer-ethynyl-benzene, vinylbenzene, polyvinylacetate, acetic acid vinyl ester, vinyl acetate, ethenyl ester, polyvinylpropionate, vinyl ester propionic acid, vinylpropionate, polyvinylchloride, chloroethylene, chloroethene, monochloroethylene, chlorethene, vinyl chloride, monchlorethene, polyvinylbutyral, polymethylmethacrylate, Vinnol H 15/50, and Vinnol E 15/45 M. The latent toned image is created on the top surface of the single, integral dielectric/adhesive/release layer.

The first step in the process of the present invention includes creating a latent toned image layer (18) by lattice deposition of an electrically charged printing medium onto the surface of the dielectric/adhesive/release layer (16). Charged styli arranged in linear arrays across the width of the moving dielectric/adhesive/release surface are used for depositing the printing medium onto the top surface of the single, integral dielectric/adhesive layer (16).

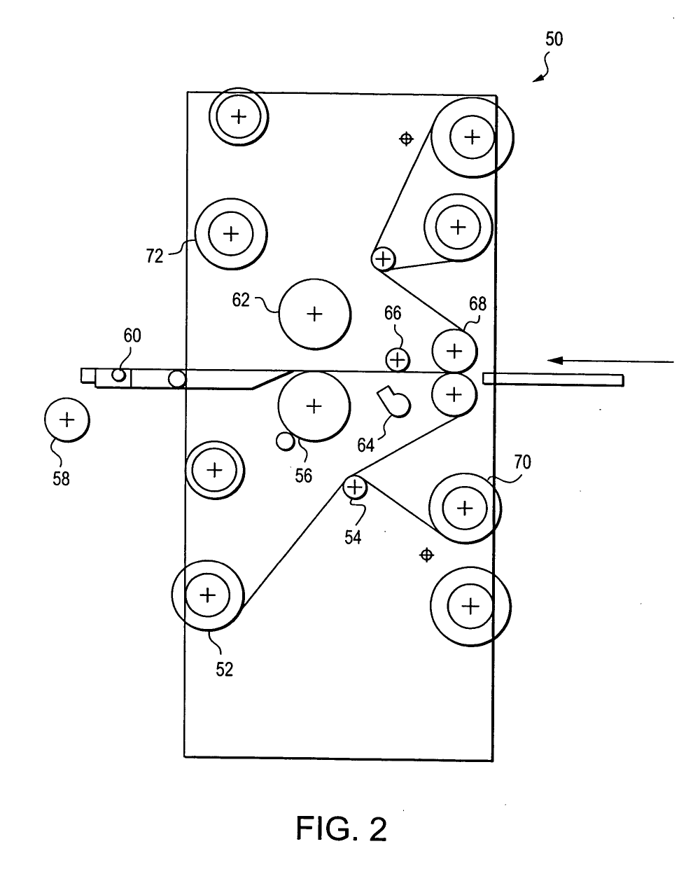

Referring to FIG. 2, the second step in the process of the present invention includes the lamination of a final substrate (20) to the electrographic receiving substrate with the use of a laminator (50). The electrographic image element (10) complete with a latent toned image layer (18) may be placed on the prints unwinder (58). The electrographic image element (10) is then fed through the laminator via the input deviating roller (60). The final substrate (20) may be place on the lower section film unwinder (52) and fed through the laminator via the deviating idle roller (54). Heat from the main upper roller (62) and main lower roller (56) softens the surface of the final substrate (20) so that it can accept the latent toned image layer (18). Temperatures for the electrographic image (10) side are preferably in the range of 50° C. to 150° C. Temperatures for the final substrate (20) side are preferably in the range of 80° C. to 150° C. The lamination temperature may be increased via a pre-heat system in which the final substrate (20) is heated above ambient temperature before placement on the electrographic imaging element (10). In addition, heat may be applied concurrent with the actual lamination step to activate the adhesive property of the single, integral dielectric/adhesive/release layer (16). The pressure of the main upper roller (62) and the main lower roller (56) causes the integral dielectric/adhesive/release layer (16) to transfer to the final substrate (20). Referring to Table 2, the pressure, speed, and temperature settings may vary and ultimately depend on the machine used. The lamination step is performed at an applied pressure, or absolute pressure applied to a unit area of the surface, in the range of 2.1 kg/cm² (30 psi) to 6.7 kg/cm² (95 psi). Applied pressure may be created via the use of platen presses; counterpoised, double roll, laminating equipment; scanning, single roll, laminating equipment; vacuum laminating equipment; and the like. Most preferably, counterpoised, double roll laminating equipment is used because it minimizes air entrapment between the final substrate (20), latent toned image (18) and the single, integral dielectric/adhesive/release (16) layer. Cooling air from the film cooling fan (64) is then directed at the area just before the cooling roller (66). The final substrate (20) bonds to the single, integral dielectric/adhesive/release layer (16) due to the pressure and/or temperature applied during the lamination step. Hence, the single, integral dielectric/adhesive/release layer (16) together with the final substrate (20) envelopes the latent toned image (18) to protect it from damage from movement, UV light degradation, bacterial degradation, mold and fungi, graffiti, or chemical degradation from water or other chemical agents, or the like.

TABLE 2
Laminator Settings

| | Temp | Temp | | |
|---|---|---|---|---|
| | Paper site | Film side | Speed | Pressure |
| Neschen Jetlam | 80-150 C. | 80-150 C. | 0.1-0.9 m/min | 30-80 psi |
| 1600 | | | | |
| Crest 1600 TTI | 60-100 C. | 100-140 C. | 0.2-1 m/min | 40-90% |
| Orca III | 50-70 C. | 110-145 C. | 0.4-2.5 m/min | 30-95 psi |

The final substrate (20) typically functions as a protective layer for the latent toned image (18). It may be any web or sheet material exhibiting the flexibility and thermal properties necessary for the lamination step. Vinyl is the most commonly used material for the final substrate.

The third step in the process of this invention is removing the final substrate (20), the latent toned image (18) and the single, integral dielectric/adhesive/release (16) layer from the base substrate (12) and conductive (14) layer. The strength of the bond between the final substrate (20) and the single, integral dielectric/adhesive/release layer (16) is greater than the strength of the bond between the single, integral dielectric/adhesive/release layer (16) and the conductive layer (14). This adhesive bonding coupled with the conductive or semi-conductive insulative properties of the co-polymers in the single, integral dielectric/adhesive/release layer (16) result in the release of the single, integral dielectric/adhesive/release layer (16) from the conductive layer (14). As a result, separation occurs at the interface of the single, integral dielectric/adhesive/release layer (16) and the conductive layer (14). The separation occurs when the final substrate (20), latent toned image (18) and single, integral dielectric/adhesive/release (16) layers are peeled from the base substrate (12) and conductive (14) layers. Referring to FIG. 2, the cooled final substrate (20) is stripped away from the electrographic image element (10) as it is fed through the pair of stretching rollers (68). The final substrate (20) complete with the latent toned image layer (18) and the single, integral dielectric/adhesive/release layer (16) are stored on the finished material rewinder (70) until the entire lamination process is complete. The spent electrographic image element (10) including the base substrate (12) and conductive (14) layer is stored on the input discard material rewinder (72) and discarded upon completion of the lamination process. The transfer rate, including the peel rate and peel force, is variable depending on the nature of the materials used in the single, integral dielectric/adhesive/release (16) and conductive (14) layers. In addition, certain final substrates (20) require a low rate when the lamination temperature is low. The transfer rate may be in the range of 0.03 meters per minute (0.1 feet per minute) to 2.4 meters per minute (8.0 feet per minute). The peeling may be done immediately after the lamination step without delamination of the final substrate (20) and toned image (18) layers from the single, integral dielectric/adhesive/release layer (16) as conducted automatically in the lamination process. Alternatively, the peel step may be performed manually just prior to mounting the latent toned image (18), including the final substrate (20) and the single, integral dielectric/adhesive/release (16) layer, onto the final site of adhesion.

The final substrate (20), latent toned image (18) and single, integral dielectric/adhesive/release (16) layer are adhered to the final site. The final site by way of example may be a billboard, banner, wall graphic, sign, advertisement, promotional piece, or decoration. In addition, the final site may be processed, treated, or coated to receive the latent toned image (18), including the final substrate (20) and single, integral dielectric/adhesive (16) layer.

Because of the generic effects the present invention is not limited solely to electrographic printing. The present invention also has capabilities on, for example, Epson printers and the like and corresponding images can be transferred as easily as those created on electrographic laminators such as the ones described herein.

Ink jet printing technologies use a process similar to spray coating. Instead of creating series of droplets the ink jet printing head produces defined droplets for each and every dot to be printed resulting in very high resolution. The inkjet printing head is an array of 256 through 1024 nozzles. Once released from the head, the droplet will pass the air gap between substrate surface and head. Depending on wetting characteristics and absorbance speed provided by the surface of the substrate, the droplet will form a wet dot. The size of the colored dot can vary between less than the original size of the droplet (bad wetting characteristics, high absorbance rate onto the substrate) or greater than the original size of the droplet (good wetting characteristics, migration across the surface of the substrate). Furthermore the ink jet printing technology can be divided into the way the droplet is created, i.e. bubble jet (thermal activated heads) or piezo heads. Thermal activated heads have short life expectancies but are technologically very important to the market. Piezo heads have a wider range of compatibility with carrier fluids to be used, are faster and have a longer life than thermal activated heads.

Thermal Heads The printing ink passes into a small chamber with an electrical heating unit. Once a droplet should be released the unit is fired with an electrical pulse heated up to evaporate the carrier liquid. Once the electrical pulse has returned to zero and the heating unit has cooled the gas will collapse and create a cavitation wave within the chamber. The liquid ink in the vicinity of the nobzzle will be pressed out because of the cavitation wave and will exit the printing head. Thermal heads have a rather limited life. Consequently, the printing head and the ink reservoir are supplied as a single unit, which is replaced when the ink container is empty.

Piezo Heads Instead of the electrical heating unit the piezo head utilizes a piezo crystal. Upon each electrical pulse the piezo crystal will expand and contract. During each phase of expansion the ink droplet will be created and exit the nozzle. Piezo heads allow users to produce different volumes of ink and, therefore, different dot sizes can be easily realized. The amplitude of the corresponding electrical pulse impacts the expansion rate of the piezo crystal. Because this process does not need any heating thermal sensitive components like inflammable solvents, thermal sensitive organic polymers can be used. Therefore, the field of application for ink jet printers with piezo heads is far wider than that for thermal heads.

The advantageous, unexpected and surprising properties of the present invention can be observed by reference to the following examples which illustrate, but are not intended to limit, the invention. In the following examples, the base materials to be coated were either aluminum foil, glass plate or polyethylene laminated paper to have a neutral base in order to evaluate release and adhesion characteristics. The coating thickness varied from 1 m to 50 μm. A variety of homopolymers were tested including Vinnolit P70 F, polyvinylfluoride, polyacryinitril, polystyrene. Tested co-polymers included Vinnol H 15/50 and Vinnol H 40/50. Experimental co-polymers were also created as detailed in Example 7 and tested.

Because of the generic effects, the application of the present invention is not limited to electrographic printing and may utilize ink jet printers as discussed previously. For instance, examples 25 and 26 demonstrate that the polymers of the present invention are suitable for ink jet printers as well, such as Epson printers and the like. In the case of ink jet printers, corresponding images can be transferred as easily as those created on an Estat machine. Polymers described herein will perform transfer regardless of the way the image has been created and can be utilized equally as well in ink jet technology as in Estat printing.

### EXAMPLE 1

1 g Polystyrene (Sigma-Aldrich Corporation, St. Louis, Mo.) MW 4000-200000, bimodal were dissolved in 8 g of Toluene at room temperature. The mixture was then coated onto glass using a Mayr rod size 2. It was dried in an oven at 105° C. for 5 minutes. The resulting coating thickness was 5 μm. The coating demonstrated good release. Mixtures were also coated on aluminum foil and polyethylene (PE) laminated paper under the same procedure. In both cases good release was achieved.

### EXAMPLE 2

1 g polyvinylfluoride (Tedlar PV 116 available from DuPont) was dissolved in 25 g of DMF at 50° C. The mixture was then coated onto a glass using a Mayr rod size 4. It was dried in an oven at 85° C. for 5 minutes. The resulting coating thickness was 5 μm. and demonstrated good release. The mixture was also coated on aluminum foil and PE laminated paper using the same procedure. In both cases good release was achieved.

### EXAMPLE 3

10 g polyacryinitrile (PAN short fibres from Schwarzwalder Textilwerke, Germany) were dissolved in 130 g of DMF at 80C. The mixture was cooled down to room temperature and then coated onto glass using a Mayr rod, size 3. It was then dried in an oven at 85° C. for 5 minutes. The resulting coating thickness was 6 μm and demonstrated good release. The mixture was also coated on aluminum foil and PE laminated paper under the same procedure. In both cases good release was achieved.

### EXAMPLE 4

Polyvinylchloride (Vinnolit P70F from Vinnolit GmbH, Germany) was coated onto glass using a Mayr rod size 1. It was dried in an oven at 85° C. for 5 minutes. The resulting coating thickness was 7 μm and could be peeled off very easily demonstrating good release. The mixture was then coated on aluminum foil and PE laminated paper under the same procedure and in both cases good release was achieved.

### EXAMPLE 5

25 g polyvinylchloride-polyvinylacetate copolymer (Vinnol H 15/50 available from Wacker Polymer Systems, Munich, Germany) was dissolved in 75 g of methyl-ethyl-ketone at room temperature. The mixture then was coated onto glass using a Mayr rod size 2. It was dried in an oven at 105° C. for 5 minutes. The resulting coating thickness was 6 μm and demonstrated good release. The mixture was coated on aluminum foil and PE laminated paper using the same procedure and in both cases good release was achieved.

### EXAMPLE 6

25 g polyvinylchloride-polyvinylacetate copolymer (Vinnol H 40/50 available from Wacker Polymer Systems, Munich, Germany) was dissolved in 75 g of methyl-ethyl-ketone at room temperature. The mixture was then coated onto a glass using a Mayr rod size 2. It was dried in an oven at 105° C. for 5 minutes. The resulting coating thickness was 6 microns and demonstrated good release being able to be peeled off easily with no residue. The mixture was coated on aluminum foil and PE laminated paper using the same procedure and in both cases good release was achieved.

### EXAMPLE 7

10 g of Vinnol H15/50 (0.84 polyvinyl chloride, 0.16 polyvinyl acetate, Wacker Polymer Systems, Munich, Germany) are dissolved in 90 g tetrachloromethane. A solution of 1.5 g of potassium hydroxide dissolved in 20 g of ethanol was added to the Vinnol H15/50/tetrachloromethane solution. The resulting mixture was then heated under reflux for 3 hours at low agitation (magnetic driven stirring unit). The mixture was washed with 50 ml of water and redissolved in 10 g of dichloromethane to run IR absorption tests. This solution was used to create a film on a silicon crystal. The transmission of a dried film from 1 sample showed that the C═O peak had disappeared with two new peaks occurring at 3434 cm⁻¹ and 3581 cm⁻¹. The corresponding alcohol, referenced herein as Polymer 1, was successfully created. Polymer 1 itself was not tested for adhesion and release but rather was used as the basis for creating Polymers 2, 3, and 4 below.

### EXAMPLE 8

2 g of Polymer 1 were dissolved in 40 g of dichloromethane. 0.5 g of potassium/sodium carbonate (ratio 1:1) and 0.5 g of acetylchloride were added to the Polymer 1/dichloromethane solution. The resulting mixture was stirred at room temperature for 3 hours. The precipitate was filtered off and the clear solution was then mixed with 0.5 g of activated carbon and filtered off again. This procedure was repeated once. The dichloromethane was evaporated by distillation and the crude polymer was washed with 10 ml of water two times. Next, the crude polymer was dissolved in 30 ml of dichloromethane and dried in a vacuum oven at 50° C. for 2 hours at 50 mm Hg pressure.

According to infrared absorption testing, the resulting adhesive/release co-polymer, was identical to Vinnol 15/50. We refer to this polymer herein as Polymer 2. The laboratory yield of Polymer 2 was 0.8 g.

A 10 wt. % solution in methyl-ethyl-ketone was coated on metal, glass and PE coated paper to a thickness of 5 Microns. In all three cases a good release was achieved.

### EXAMPLE 9

2 g of Polymer 1 from Example 6 were dissolved in 40 g of dichloromethane. 0.5 g of potassium/sodium carbonate (ratio 1:1) followed by 0.6 g of propionylchloride were added to the Polymer 1/dichloromethane solution. The resulting mixture was stirred at room temperature for 3 hours. The precipitate was filtered off and the filtrate was then mixed with 0.5 g of activated carbon and filtered again. This procedure was repeated once. The dichloromethane was evaporated by distillation and the crude polymer was washed with 10 ml of water twice. Next, the crude polymer was dissolved in 30 ml of dichloromethane and dried in a vacuum oven at 50° C. for 2 hours at 50 mm Hg pressure. The resulting polymer was polyvinylpropionate and is referred to herein as Polymer 3. The laboratory yield of Polymer 3 was 0.9 g.

A 10 wt. % solution of Polymer 3 dissolved in methyl-ethyl-ketone was coated on metal, glass and PE coated paper to a thickness of 5 μm. Only in the case of aluminium was release achieved. The polymer adhered to the other substrates and release could not be achieved. As demonstrated by this Example 9, by increasing the chain the point is reached where the adhesive properties of the polymer are stronger than the release properties.

### EXAMPLE 10

2 g of Polymer 1 were dissolved in 40 g of dichloromethane. 0.5 g of potassium/sodium carbonate (ratio 1:1) followed by 0.75 g of butyrylchloride were added to the Polymer 1-dichloromethane solution. The resulting mixture was stirred at room temperature for 3 hours.

The precipitate was filtered off. The clear solution was then mixed with 0.5 g of activated carbon and again filtered off. This procedure was then repeated. The dichloromethane was evaporated by distillation and the crude polymer was washed with 10 ml of water twice. The crude polymer was then dissolved in 30 ml of dichloromethane and dried in a vacuum oven at 50° C. for 2 hours at 50 mm Hg pressure. The resulting polymer is Polyvinylbutyrate referred to herein as Polymer 4. The laboratory yield of Polymer 4 was 0.9 g.

A 10 wt. % of Polymer 4 dissolved in methyl-ethyl-ketone was coated on metal, glass and PE coated paper to a thickness of 5 μm. Release was not achieved on any of the three substrates but perfect adhesion was obtained on all substrates again demonstrating that the longer the polymeric chain the more likely the adhesive properties will be stronger than the release properties.

Table 3 summarizes the results set forth in the Examples. All homopolymers perform release. The chosen copolymer vinylacetate will work as well even at high mole fraction. Thus, using an extended chain instead of acetyl will impact the release ability very negatively. The experimental polymer was created to show the induction effect is more important then the amount or the mol fraction for the corresponding copolymer.

TABLE 3
Adhesion/Release Properties

| Polymer | Chemical nature | PE paper | Alu foil | Glass |
|---|---|---|---|---|
| Homopolymers | | | | |
| Vinnolit P70 F | 1 PVC | R+ | R+ | R+ |
| Polyvinylfluoride | 1 PVF | R+ | R | R |
| Polyacrylnitril | 1 PAN | R+ | R+ | R+ |
| Polystyrene | 1 PS | R+ | R+ | R+ |
| Copolymers | | | | |
| Vinnol H 15/50 | 0.84 VCl; 0.16 VAc | R+ | R | R |
| Vinnol H 40/50 | 0.62 VCl, 0.38 VAc | R+ | R+ | R+ |
| Polymer 2 | 0.84 VCl; 0.16 VAc | R+ | R | R |
| Polymer 3 | 0.84 VCl; 0.16 | A+ | R | A+ |
| | Vinylpropionate | | | |
| Polymer 4 | 0.84 VCl; 0.16 | A+ | A+ | A+ |
| | Vinylbutyrate | | | |

### EXAMPLE 11

15 g polystyrene (Sigma-Aldrich Corporation, St. Louis, Mo.) MW 4000-200000, bimodal were dissolved in 85 g of Toluene at room temperature. The mixture was then coated on the electro-conductive base described herein using a Mayr rod. The resulting coating weight was 5.4 g/sqm. The sample was fed through a Neschen Jet Lam 1600 laminator. As a substrate, a self-adhesive vinyl film was used (3M 8620, 3M, St. Paul, Minn.) at 140° C. at the film side and 100° C. on the paper side. The pressure was set at 8 which is approximately equivalent to 30 psi. The coating was completely transferred to the 8620 film and could be peeled off very easily achieving good release.

### EXAMPLE 12

15 g polyvinylchloride (Vinnolit P 70 F from Vinnolit GmbH, Germany), were dissolved in 85 g Methyl-ethyl-ketone at room temperature. To this solution 5 g polyvinylacetate, (Vinnapas BP 50 F from Wacker Polymer Systems, Munich, Germany) dissolved in ethyl acetate to a solid content of 50 wt. % was added. The mixture was then coated on the electroconductive base disclosed herein using a Mayr rod. The resulting coating weight was 5.0 g/sqm. The sample was fed through a Neschen Jet Lam 1600 laminator. Substrate 3M 8620 as in Example 11 was used at 140° C. at the film side and 100° C. on the paper side. The pressure was set at 8 which is equivalent to 30 psi. The coating was completely transferred to the 8620 film and could be peeled off very easily demonstrating good release.

### EXAMPLE 13

15 g polyvinylchloride (Vinnolit P 70 F available from Vinnolit GmbH, Germany) were dissolved in 85 g methyl-ethyl-ketone at room temperature. To this solution a solution of 2.6 g polyvinylbutyral (Mowital B 30 H available from Clariant International, Switzerland) in 10.5 g methanol was added. The mixture was then coated on the electroconductive base disclosed herein using a Mayr rod. The resulting coating weight was 3.0 g/sqm.

The sample was fed through a laminator Neschen Jet Lam 1600. Substrate 3M 8620 as in Example 11 was used at 140° C. at the film side and 100° C. on the paper side. The pressure was set at 8 which is equivalent to 30 psi. The coating was completely transferred to the 8620 film and could be peeled off very easily demonstrating good release.

### EXAMPLE 14

15 g polystyrene (Sigma-Aldrich Corporation, St. Louis, Mo.) with a molecular weight of 250,000 were dissolved in 85 g of Toluene at room temperature. To this mixture a solution of 3.5 g acrylo-methyl-methacrylate copolymer (Paraloid B-65 available from Rohm & Haas, Philadelphia, Pa.) in 8.0 g toluene was added. The mixture was then coated on the electroconductive base disclosed herein using a Mayr rod. The resulting coating weight was 5.0 g/sqm. The sample was fed through a Neschen Jet Lam 1600 laminator. Substrate 3M 8620 was used at 140° C. at the film side and 100° C. on the paperside. The pressure was set at 8 which is equivalents to 30 psi. The pressure was set at 8 which is equivalent to 30 psi. The coating was completely transferred to the 8620 film and could be peeled off very easily demonstrating good release.

### EXAMPLE 15

15 g polystyrene (Sigma-Aldrich Corporation, St. Louis, Mo.) with a molecular weight of 250,000 was dissolved in 85 g of toluene at room temperature. To this mixture a solution of 3.7 g polyacrylate (Viacryl VSC 1011 available from UCB, Belgium) dissolved in 5.6 g toluene was added. The mixture was then coated on the electroconductive base disclosed herein using a Mayr rod. The resulting coating weight was 4.3 g/sqm. The sample was fed through a Neschen Jet Lam 1600 laminator. Substrate 3M 8620 was used at 140° C. at the film side and 100° C. on the paperside. The pressure was set at 8 which equals to 30 psi. The pressure was set at 8 which is equivalent to 30 psi. The coating was completely transferred to the 8620 film and could be peeled off very easily demonstrating good release.

### EXAMPLE 16

15 g polyacryinitrile fibers at a mesh density of 6.7 dtex/2 mm (Schwarzwalder Texilwerke, Germany) were dissolved in 85 g dimethylformamide at room temperature. To this mixture a solution of 4.5 g polyacrylate (Viacryl VSC 1011, UCB, Belgium) in 6.75 g toluene was added. The mixture was then coated on the electroconductive base disclosed herein using a Mayr rod. The resulting coating weight was 5.5 g/sqm. The sample was fed through a Neschen Jet Lam 1600 laminator. Substrate 3M 8620 was used at 140° C. at the film side and 100° C. on the paperside. The pressure was set at 8 which equals to 30 psi. The pressure was set at 8 which is equivalent to 30 psi. The coating was completely transferred to the 8620 film and could be peeled off very easily demonstrating good release.

### EXAMPLE 17

Base paper, referred to herein as base #1, was prepared as follows. 80 g/sqm copy paper was coated with an electroconductive resin (Chemistat 5300H available from Sanyo Chemical, Japan) on both sides. The Chemistat was diluted with methanol from 33% to 8% to allow penetration into the base. Onto the smoother side of the paper the following recipe was coated at 8 g/sqm: 12 g of starch (Solvitose available from Avebe, Germany) dissolved in 76 g of hot water at 80° C. The mixture was cooled down to 30° C. and 26 g of Chemistat (33% solids) was added. The mixture was stirred for 10 minutes with a low shearing unit. Then 32 g of China Clay (Supramatt 65 available from Imerys, UK) was added. The mixture was then treated with a lab ultrasonic unit consuming 900 W for 2.5 minutes. The resulting mixture was coated on copy paper with a Mayr rod at 8 g/sqm. The surface was calandered to achieve a Bekk smoothness of 200 sec.

### EXAMPLE 18

Base paper, referred to herein as base #2, was prepared as follows. Inline coated paper available from SIHL Zurich AG was made from raw paper containing 60% of sulfite treated fibres, 20% hardwood and 20% Intrafill C (a clay available from Imerys, UK). The material had 2 g of size coating on each side. The size formula had 60% Perfectamyl (a starch available from Avebe, Germany) and 40% Induquat ECR 79 (an electroconductive resin available from Indulor, Germany). The front side of the paper had a 3 g per sqm coat weight of 50% Perfectamyl, 40% Induquat and 10% Supragloss (a clay available from Imerys, UK). The backside had coatweight of 1 g containing Induquat. The resulting base paper product had a smoothness range of 150 to 250 sec measured according to Bekk.

### EXAMPLE 19

On conductive base paper base #1 the following mixture was coated using a Mayr rod:

| Chemical | Weight in Grams |
|---|---|
| Toluene | 60 |
| Vinnol H15/50 (1) | 13 |
| Methyl-ethyl-ketone (MEK) | 27 |
| Pergopak M2 (2) | 0.4 |

(1) PVC/PVac-copolymer produced by Wacker Polymer Systems.
(2) Pergopak M2 organic pigment on basic of Urea-Formaldehyde condensate available from Alusuisse Martinswerk GmbH, Germany; particle range 3 until 7.5 μm.

The Vinnol H15/50 was dispersed in toluene by stirring and after 5 minutes with MEK dissolved. To the clear polymer solution 0.4 g Pergopak M2 was added and milled with 40 g glass spheres (diameter 1-1.5 mm) for 45 minutes. The mixture was then coated on conductive base paper #1 with a dry coating weight of 4.5 g/sqm. After 24 hours at room temperature the probe was plotted with tesffile (colorbars) on a Xerox 8954 electrostatic printer. The transfer properties on a vinylfilm were controlled by using a laminator Crest 1600 TTL at the following conditions:

transfer medium: banner material (grade 8451 available from 3M, St. Paul, Minn.)

| | | |
|---|---|---|
| temperatures: | upper roll | 150° C. |
| | down roll | 70° C. |
| pressure: | hot rolls | .44 N/sq cm |
| | cold rolls | .14 N/sq cm |
| transfer speed: | | 0.5 m/min. |

The transfer of the color bars demonstrated good release and the paper substrate could be removed very easily.

### EXAMPLE 20

This example shows the use of an organic pigment in the dielectric formulation according to the invention. The coating solution was prepared as follows:

| Chemical | weight in grams |
|---|---|
| Toluene | 58 |
| Vinnol H15/50 | 16 |
| Methyl-ethyl-ketone (MEK) | 27 |
| Syloid AL1* | 0.33 |

*available from Grace Davison, Germany; average particle size 6.5-8.5 μm added as slurry; The slurry is made using a mixture of toluene/methyl-ethyl-ketone (2/1 by weight) at a solid concentration of 32 wt. %.

The Vinnol H15/50 was dispersed in toluene under stirring and after 5 minutes with MEK dissolved. After this 1.1 g Syloid AL 1-slurry was added to the clear polymer solution and stirred 20 minutes with a toothed disc stirrer. The mixture was then coated on conductive base paper #1 with a dry coating weight of 5.5 g/sqm. The test conditions were the same as in Example 19. The color bars were completely transferred onto banner material and the release from the paper substrate was performed easily with no residue remaining on the paper (good release).

### EXAMPLE 21

9 g polyvinylchloride/polyvinylacetate-Copolymer, Vinnol H15/50 (Wacker) was dissolved in 26 g toluene and 13 g methyl-ethyl-ketone at room temperature and 2 g calcium carbonate, (Omya BL200 available from Omya, Finland) was dispersed therein (referred to herein and herinafter as composition A ). To this composition 60 mg stearic acid (Fluka, Switzerland) in 3 g toluene was added. The resulting mixture was coated on electroconductive base paper #2 using a Mayr rod size 35. The coating weight was 5.5 g/sqm. The transfer properties were tested using a laminator Neschen Jet Lam 1600 on substrate 8451 (3M). The substrate was used at 100° C. of the paper side and at 140° C. at the film side and at a pressure of 30 psi. The transfer of the dielectric-layer was complete to the banner 8451 and the paper released very easily with no remaining residue.

### EXAMPLE 22

60 mg stearyl alcohol (Fluka, Switzerland) in 3 g toluene was added to 50 g of composition A. The mixture was coated and tested as in Example 21. The resulting coating weight was 6.1 g/sqm. The transfer of the dielectric layer was complete demonstrating good release with no remaining residue resulting in excellent image quality.

### EXAMPLE 23

60 mg lauric acid (Fluka, Switzerland) in 3 g Toluene was added to 50 g composition A. The mixture was coated and tested as in Example 21. The resulting coating weight was 6.1 g/sqm. The transfer of the dielectric layer demonstrated good release with no remaining residue on the conductive base and had excellent image quality.

### EXAMPLE 24

60 mg behenic (docosanoic) acid (Fluka, Switzerland) in 3 g toluene was added to 50 g composition A. The mixture was coated and tested as in Example 5. The resulting coating weight was 6.6 g/sqm. The transfer of dielectric layer and the release performance were comparable to Example 21.

### EXAMPLE 25

Coated samples from Example 18 were printed on an Epson Stylus Printer Pro 9600. The ink limit was reduced to 40% for each color. The samples were dried in three different ways: (i) allowing the sample to dry at room temperature conditions (22° C., 50% relative humidity); (ii) drying under infrared light 500 watts for 5 minutes; and (iii) drying in an oven at 85° C. for 5 minutes. The transfer of the dielectric layer demonstrated good release with no remaining residue on the conductive base. Excellent image quality was demonstrated with conditions (i) and (ii) above.

### EXAMPLE 26

25 g polyvinylchloride-polyvinylacetate copolymer (Vinnol H 15/50 available from Wacker Polymer Systems, Munich, Germany) was dissolved in 75 g of methyl-ethyl-ketone at room temperature. The mixture was coated onto glass using a Mayr rod size 10. It was dried in an oven at 105° C. for 5 minutes. The resulting coating thickness was 16 μm coated on the electroconductive base disclosed herein. The sheet was printed on a Mimaki JV3 printer using solvent-based inks. Excellent image quality was obtained. The image was easily transferred to banner material (grade 8451 available from 3M, St. Paul, Minn.).

1. An electrographic element comprising, in order, a base substrate, a conductive layer, a single, integral dielectric/adhesive/release layer upon which an image is deposited, and a final substrate.

2. An electrographic element having a single, integral dielectric/adhesive/release layer, the dielectric/adhesive/release layer comprising a co-polymer having the structure —[CH₂CHX]— . . . —[CH₂—CHY]; wherein X is selected from the group consisting essentially of —CN, —NO₂, —Br, —Cl, —F, —I and -AR; wherein Y is selected from the group consisting essentially of polyvinyl acetate, an acrylic ester, and polyvinylbutyral, wherein X has a high negative induction effect on the co-polymeric structure, wherein —[CH₂CHX] imparts release characteristics and —[CH₂—CHY]— imparts adhesive characteristics to the dielectric/adhesive/release layer.

3. The electrographic element of claim 2 wherein X is polyvinylchloride and Y is polyvinyl acetate.

4. The electrographic element of claim 3 wherein the [CH₂CHX]— comprises from 10% to 99% of the co-polymer and —[CH₂—CHY]— comprises from 90% to 1% of the co-polymer.

5. The electrographic element of claim 2 wherein Y is an acrylic ester selected from the group consisting essentially of methyl, ethyl, and butyl.

6. The electrographic element of claim 5 wherein the acrylic ester is butyl ester.

7. The electrographic element of claim 2 wherein the single, integral dielectric/adhesive/release layer includes a fatty acid.

8. The electrographic element of claim 7 wherein the fatty acid is a higher fatty acid.

9. The electrographic element of claim 8 wherein the higher fatty acid is selected from a group consisting essentially of pelargonic, lauric, myristic, palmitic and stearic.

10. The electrographic element of claim 8 wherein the higher fatty acid is stearic.

11. The electrographic element of claim 10 wherein the fatty acid is present in an amount from about 0.05 wt. % to about 0.5 wt. %.

12. The electrographic element of claim 2 wherein the single, integral dielectric/adhesive/release layer includes a fatty alcohol selected from the group consisting essentially of pelargonyl, lauryl, myristyl, palmityl and stearyl.

13. The electrographic element of claim 12 wherein the fatty alcohol is stearyl.

14. The electrographic element of claim 12 wherein the fatty alcohol is present in an amount from about 0.05 wt. % to about 0.5 wt. %.

15. The electrographic element of claim 13 wherein stearyl alcohol is present in an amount from about 0.05 wt. % to about 0.5 wt. %.

16. The electrographic element of claim 15 wherein stearyl alcohol is present in an amount equal to about 0.2 wt. %.

17. A method of producing an imaged article comprising (i) depositing an electrostatic charge in image-wise fashion onto an image receptive surface of an electrographic element, the electrographic element comprising in order (a) a base substrate; (b) a conductive layer; and (c) a single, integral charge-receptive dielectric/release/adhesive layer; (ii) applying a toner layer onto the single, integral charge-receptive dielectric layer to produce a toned image; (iii) contacting the toned image surface of the single dielectric/release/adhesive layer with a final substrate at a temperature and pressure sufficient to activate the adhesive properties of the single dielectric layer to adhere the electrographic element to the final substrate; (iv) releasing the single, integral charge-receptive dielectric/release/adhesive layer containing the toned image and final substrate from the conductive base to produce an imaged article.

18. The method of claim 17 wherein the single, integral dielectric/adhesive/release layer comprises an aliphatic co-polymer having the structure —[CH₂CHX]— . . . —[CH₂—CHY]; X selected from the group consisting essentially of —CN, —NO₂, —Br, —Cl, —F, —I and -AR; Y selected from the group consisting essentially of polyvinyl acetate, an acrylic ester, and polyvinylbutyral, wherein X has a high negative induction effect on the co-polymeric structure, wherein —[CH₂CHX]— imparts release characteristics and —[CH₂—CHY]— imparts adhesive characteristics to the dielectric/adhesive/release layer.

19. The electrographic element of claim 18 wherein X is polyvinyichloride and Y is polyvinyl acetate.

20. The electrographic element of claim 18 wherein [CH₂CHX]— comprises from 10% to 99% of the co-polymer and —[CH₂—CHY] comprises from 90% to 1% of the co-polymer.

21. The electrographic element of claim 18 wherein Y is an acrylic ester selected from the group consisting essentially of methyl, ethyl, and butyl esters.

22. The electrographic element of claim 5 wherein the acrylic ester is butyl ester.

23. The electrographic element of claim 18 wherein the single, integral dielectric/adhesive/release layer includes a fatty acid.

24. The electrographic element of claim 23 wherein the fatty acid is a higher fatty acids.

25. The electrographic element of claim 24 wherein the higher fatty acid is selected from a group consisting essentially of pelargonic, lauric, myristic, palmitic and stearic.

26. The electrographic element of claim 25 wherein the higher fatty acid is stearic.

27. The electrographic element of claim 23 wherein the fatty acid is present in an amount from about 0.05 wt. % to about 0.5 wt. %.

28. The electrographic element of claim 18 wherein the single, integral dielectric/adhesive/release layer includes a fatty alcohol selected from the group consisting essentially of pelargonyl, lauryl, myristyl, palmityl and stearyl.

29. The electrographic element of claim 28 wherein the fatty alcohol is stearyl.

30. The electrographic element of claim 28 wherein the fatty alcohol is present in an amount from about 0.05 wt. % to about 0.5 wt. %.

31. The electrographic element of claim 29 wherein stearyl alcohol is present in an amount from about 0.05 wt. % to about 0.5 wt. %.

32. The electrographic element of claim 31 wherein stearyl alcohol is present in an amount equal to about 0.2 wt. %.

33. An electrographic element having a single, integral dielectric/adhesive/release layer, the dielectric/adhesive/release layer comprising a blend of homopolymers A and B, A having the structure [CH₂CHX], wherein X is selected from the group consisting essentially of —CN, —NO₂, —Br, —Cl, —F, —I and -AR; and wherein X has a high negative induction effect on the entire co-polymeric structure and wherein [CH₂CHX] imparts release characteristics; and B having the structure [CH₂—CHY]; wherein Y is selected from the group consisting essentially of polyvinyl acetate, polybutyral, and an acrylic ester; and wherein [CH₂—CHY] imparts adhesive characteristics to the dielectric/adhesive/release layer.

34. The electrographic element of claim 33 wherein X is polyvinylchloride and Y is polyvinyl acetate.

35. The electrographic element of claim 33 wherein A is present in an amount equal to from about 30 wt. % to about 100 wt. % and B is present in an amount equal to from about 70 wt. % to about 0 wt. %.

36. The electrographic element of claim 33 wherein Y is an acrylic ester selected from the group consisting essentially of methyl, ethyl, and butyl.

37. The electrographic element of claim 36 wherein the acrylic ester is butyl ester.

38. The electrographic element of claim 33 wherein the single, integral dielectric/adhesive/release layer includes a fatty acid.

39. The electrographic element of claim 38 wherein the fatty acid is a higher fatty acid.

40. The electrographic element of claim 39 wherein the higher fatty acid is selected from a group consisting essentially of pelargonic, lauric, myristic, palmitic and stearic.

41. The electrographic element of claim 39 wherein the higher fatty acid is stearic.

42. The electrographic element of claim 38 wherein the fatty acid is present in an amount from about 0.05 wt. % to about 0.5 wt. %.

43. The electrographic element of claim 38 wherein the single, integral dielectric/adhesive/release layer includes a fatty alcohol selected from the group consisting essentially of pelargonyl, lauryl, myristyl, palmityl and stearyl.

44. The electrographic element of claim 43 wherein the fatty alcohol is stearyl.

45. The electrographic element of claim 43 wherein the fatty alcohol is present in an amount from about 0.05 wt. % to about 0.5 wt. %.

46. The electrographic element of claim 44 wherein stearyl alcohol is present in an amount from about 0.05 wt. % to about 0.5 wt. %.

47. The electrographic element of claim 15 wherein stearyl alcohol is present in an amount equal to about 0.2 wt. %.

48. The electrographic element of claim 38 wherein the element is printed on a piezo head ink jet printer.

49. The electrographic element of claim 38 wherein the element is printed on a thermal head inkjet printer.
